(19) United States
(12) Patent Application Publication
(10) Pub. No.: US 2020/0051176 A1
(43) Pub. Date: Feb. 13, 2020

(54) ANALYSIS SYSTEM

(71) Applicant: NEC Corporation, Minato-ku, Tokyo (JP)

(72) Inventors: Jianquan LIU, Tokyo (JP); Shoji NISHIMURA, Tokyo (JP); Yasufumi HIRAKAWA, Tokyo (JP)

(73) Assignee: NEC Corporation, Minato-ku, Tokyo (JP)

(21) Appl. No.: 16/499,385

(22) PCT Filed: Nov. 29, 2017
(86) PCT No.: PCT/JP2017/042866

§ 371 Date: Sep. 30, 2019

(30) Foreign Application Priority Data
Mar. 31, 2017 (JP) 2017-072161

(51) Int. Cl. G06Q 40/00; G06Q 30/00

(52) U.S. Cl. CPC G06Q 40/12; G06Q 30/0185

(57) ABSTRACT

According to the present invention, an analysis system (10) including a generation unit (11) that generates frequency data indicating a temporal change in an occurrence frequency of a predetermined event for each processing object, and an extraction unit (12) that extracts the processing object having a first feature appearing in the frequency data as a possible abnormal object is provided.

### TECHNICAL FIELD

The present invention relates to an analysis system, an analysis method, and a program.

### BACKGROUND ART

A technology related to the present invention is disclosed in Patent Document 1. In Patent Document 1, an information processing apparatus that detects abnormal monetary transactions is disclosed. The information processing apparatus receives a face image obtained by capturing the face of a user and data of the amount of money of a transaction in a monetary transaction from a terminal apparatus on which an operation for the monetary transaction is performed. The information processing apparatus determines whether or not the monetary transaction is abnormal on the basis of the contents of the monetary transactions of the person up to the present time.

In the disclosure, for example, in a case where the total value of the amounts of money in transfer transactions performed in a predetermined period by the same person is above a threshold, it is determined that the monetary transaction is abnormal. Besides, in the disclosure, in a case where the ratio of the amount of money of a new transfer transaction to the average amount of money of transaction per transfer transaction performed in the predetermined period by the same person is above a threshold, it is determined that the monetary transaction is abnormal.

### RELATED DOCUMENT

### Patent Document

[Patent Document 1] Japanese Laid-open Patent Publication No. 2010-282262

[Patent Document 2] International Publication No. 2014/109127

[Patent Document 3] Japanese Laid-open Patent Publication No. 2015-49574

### SUMMARY OF THE INVENTION

### Technical Problem

An object of the present invention is to provide a new technology for detecting an abnormal transaction.

### Solution to Problem

According to the present invention, an analysis system including a generation unit that generates frequency data indicating a temporal change in an occurrence frequency of a predetermined event for each processing object, and an extraction unit that extracts the processing object having a first feature appearing in the frequency data as a possible abnormal object is provided.

In addition, according to the present invention, an analysis method executed by a computer, which includes: a generation step of generating frequency data indicating a temporal change in an occurrence frequency of a predetermined event for each processing object, and an extraction step of extracting the processing object having a first feature appearing in the frequency data as a possible abnormal object is provided.

In addition, according to the present invention, a program causing a computer to function as a generation unit that generates frequency data indicating a temporal change in an occurrence frequency of a predetermined event for each processing object, and an extraction unit that extracts the processing object having a first feature appearing in the frequency data as a possible abnormal object is provided.

### ADVANTAGEOUS EFFECTS OF INVENTION

According to the present invention, a new technology for extracting an object having a possibility of an abnormal transaction is achieved.

### BRIEF DESCRIPTION OF THE DRAWINGS

The above object and other objects, features, and advantages will become more apparent from example embodiments set forth below and the following drawings appended thereto.

FIG. 1 is a diagram conceptually illustrating one example of a hardware configuration of an analysis system of the present example embodiment.

FIG. 2 is one example of a function block diagram of the analysis system of the present example embodiment.

FIG. 3 is one example of a function block diagram of the analysis system of the present example embodiment.

FIG. 4 is one example of a function block diagram of the analysis system of the present example embodiment. FIG. 5 is a diagram for describing an underlying technology of the present example embodiment.

FIG. 6 is a diagram for describing the underlying technology of the present example embodiment.

FIG. 7 is a diagram for describing a process example of the analysis system of the present example embodiment.

FIG. 8 is a diagram for describing one example of data processed in the analysis system of the present example embodiment.

FIG. 9 is a diagram for describing one example of data processed in the analysis system of the present example embodiment.

FIG. 10 is a diagram for describing one example of data processed in the analysis system of the present example embodiment.

FIG. 11 is a diagram for describing one example of data processed in the analysis system of the present example embodiment.

FIG. 12 is one example of a function block diagram illustrating a relationship between the analysis system of the present example embodiment and other apparatuses.

FIG. 13 is a flowchart illustrating one example of a flow of process of the analysis system of the present example embodiment.

FIG. 14 is a flowchart illustrating one example of the flow of process of the analysis system of the present example embodiment.

FIG. 15 is a flowchart illustrating one example of the flow of process of the analysis system of the present example embodiment.

FIG. 16 is a flowchart illustrating one example of the flow of process of the analysis system of the present example embodiment.

FIG. 17 is one example of a function block diagram of the analysis system of the present example embodiment.

FIG. 18 is one example of a function block diagram of the analysis system of the present example embodiment.

FIG. 19 is a diagram for describing one example of data processed in the analysis system of the present example embodiment.

### DESCRIPTION OF EMBODIMENTS

### First Example Embodiment

First, main features of an analysis system of the present example embodiment will be briefly described. The analysis system of the present example embodiment has at least one of a plurality of main features described below.

“Feature A”

The analysis system of the present example embodiment extracts a person from image data obtained by capturing the site of a transaction and generates frequency data indicating a temporal change in the occurrence frequency of a transaction (predetermined event) for each extracted person (for each processing object). A person having a high frequency of appearing in the image data is a person having a high occurrence frequency of transaction. For example, the transaction is a transaction using an automatic teller machine (ATM).

The analysis system extracts a person (processing object) having a first feature appearing in the frequency data as a possible person (possible abnormal object) as an abnormal processing object. The first feature is a feature appearing in the past frequency obtained in the presence of an abnormal transaction. Details of the first feature will be described below.

The abnormal transaction is a transaction related to crime or other troubles. The person who is the possible abnormal object is a person having a possibility of performing the abnormal transaction.

According to the analysis system of the present example embodiment, on the basis of the tendency of temporal change in the occurrence frequency of the transaction, the person having the possibility of performing the abnormal transaction can be extracted without using information indicating a transaction content (example: the amount of money of the transaction).

“Feature B”

According to the analysis system of the present example embodiment, a person having a second feature appearing in the frequency data can be excluded from persons who are the possible abnormal objects. The second feature is a feature appearing in the past frequency data obtained in the absence of abnormality. Details of the second feature will be described below.

According to the analysis system of the present example embodiment, on the basis of the tendency of temporal change in the occurrence frequency of the transaction, a person having a high possibility of performing a normal transaction can be excluded from persons extracted as the person having the possibility of performing the abnormal transaction without using the information indicating the transaction content.

“Feature C”

In addition, according to the analysis system of the present example embodiment, a determination as to whether or not the person who is the possible abnormal object is a person (abnormal transactor) performing the abnormal transaction can be performed on the basis of a transaction history of a transaction terminal. By narrowing down possible abnormal objects using the frequency data and the transaction history, the abnormal transactor having a high possibility of actually performing the abnormal transaction can be accurately extracted.

It should be noted that in the case of the analysis system of the present example embodiment, it is not necessary to use the transaction histories of all persons. Only the transaction history of a part of persons especially determined as the possible abnormal object may be used. Thus, abuse of private information can be reduced.

“Feature D”

In addition, according to the analysis system of the present example embodiment, information indicating a person determined as the abnormal transactor can be transmitted to the transaction terminal. The transaction terminal can determine whether or not a person operating the terminal is a listed person using a list of persons determined as the abnormal transactor. In a case where a person on the list is detected, the transaction can be stopped, or a predetermined user can be notified.

Next, a configuration of the analysis system will be described in detail. First, one example of a hardware configuration of the analysis system will be described. The analysis system is configured by any combination of hardware and software of any computer focusing on a central processing unit (CPU), a memory, a program loaded in the memory, a storage unit (can store not only the program stored in advance in the stage of shipping the apparatus but also the program in a storage medium such as a compact disc (CD) or downloaded from a server or the like on the Internet) such as a hard disk storing the program, and a network connection interface. Those skilled in the art will perceive various modification examples of the configuration method and the apparatus.

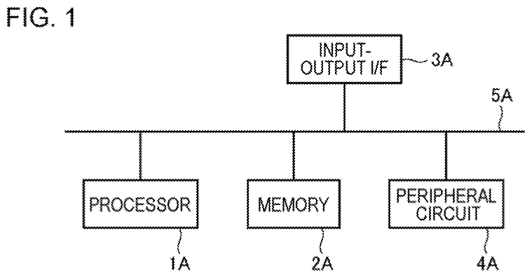

FIG. 1 is a block diagram illustrating the hardware configuration of the analysis system. As illustrated in FIG. 1, the analysis system includes a processor 1A, a memory 2A, an input-output interface 3A, a peripheral circuit 4A, and a bus 5A. The peripheral circuit 4A includes various modules.

The bus 5A is a data transfer path for transmission and reception of data among the processor 1A, the memory 2A, the peripheral circuit 4A, and the input-output interface 3A. The processor 1A is an operation processing apparatus such as a central processing unit (CPU) or a graphics processing unit (GPU). The memory 2A is a memory such as a random access memory (RAM) or a read only memory (ROM). The input-output interface 3A includes, for example, an interface for obtaining information from an input apparatus (example: a keyboard, a mouse, a microphone, a physical key, a touch panel display, or a card reader), an external apparatus, an external server, an external sensor, and the like, and an interface for outputting information to an output apparatus (example: a display, a speaker, a printer, and a mailer), the external apparatus, the external server, and the like. The processor 1A can output an instruction to each module and perform an operation on the basis of the operation results of the modules.

The analysis system may be configured with one physically and/or logically integrated apparatus or may be configured with a plurality of physically and/or logically separated apparatuses. In the case of the configuration as the plurality of apparatuses, the plurality of apparatuses are configured to transmit and receive information with each other, and the plurality of apparatuses implement the function of the analysis system in cooperation with each other.

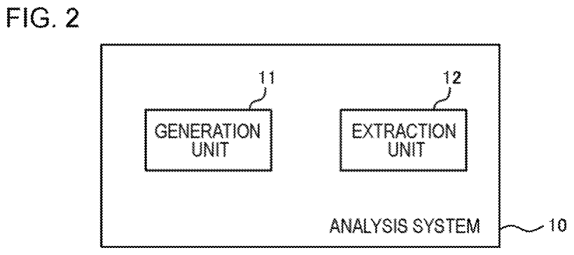

FIG. 2 illustrates one example of a function block diagram of an analysis system 10. As illustrated, the analysis system 10 includes a generation unit 11 and an extraction unit 12.

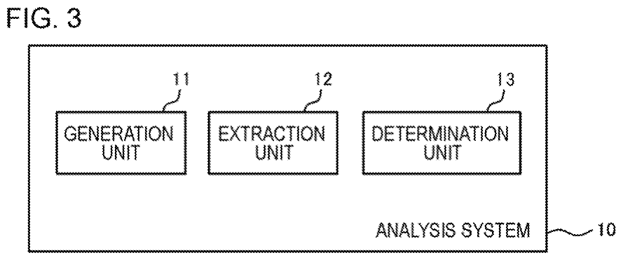

FIG. 3 illustrates another example of the function block diagram of the analysis system 10. As illustrated, the analysis system 10 may include a determination unit 13 in addition to the generation unit 11 and the extraction unit 12.

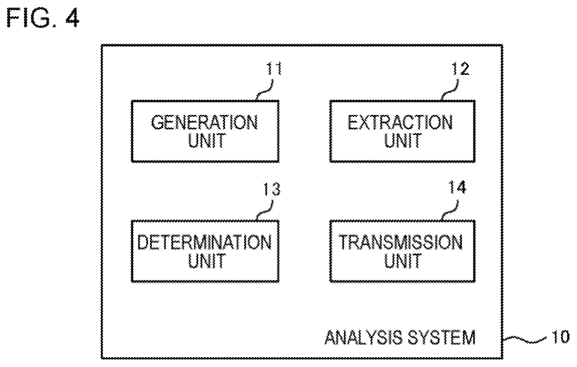

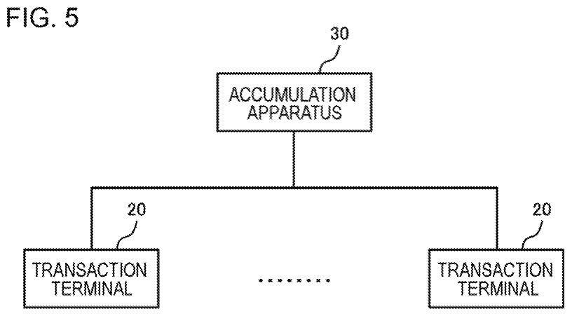

FIG. 4 illustrates another example of the function block diagram of the analysis system 10. As illustrated, the analysis system 10 may include a transmission unit 14 in addition to the generation unit 11, the extraction unit 12, and the determination unit 13.

The generation unit 11 generates the frequency data indicating a temporal change in the occurrence frequency of the predetermined event for each processing object. The predetermined event is a transaction (example: deposit, withdrawal, transfer, or bank-book updating) using an ATM. The processing object is a person performing the monetary transaction.

An underlying technology of the present example embodiment will be described. The underlying technology is common in all example embodiments below. As illustrated in FIG. 5, a plurality of transaction terminals 20 (ATMs) are configured to be capable of communicating with an accumulation apparatus 30 by any communication unit.

The transaction terminal 20 transmits the transaction history to the accumulation apparatus 30. The accumulation apparatus 30 accumulates the transaction history received from each of the plurality of transaction terminals 20. For example, the transaction history includes a transaction date and time and information input through the transaction terminal 20. For example, the information input through the transaction terminal 20 is illustrated as information (example: the amount of money of the transaction or a transaction type (example: deposit, withdrawal, transfer, or bank-book updating)) input by operating a touch panel display, a physical key, or the like included in the transaction terminal 20 and information obtained from a card (example: an IC card or a magnetic card) of a customer.

In addition, the transaction terminal 20 includes a camera and captures the face of the person performing the transaction at any timing. For example, the capturing may be performed at a timing at which a predetermined operation (example: insertion of the card or a predetermined input) is performed on the transaction terminal 20, or the capturing may be performed at a timing at which the transaction terminal 20 performs a predetermined operation (example: withdrawal). The transaction terminal 20 transmits an image file of a generated still picture to the accumulation apparatus 30 in association with each transaction.

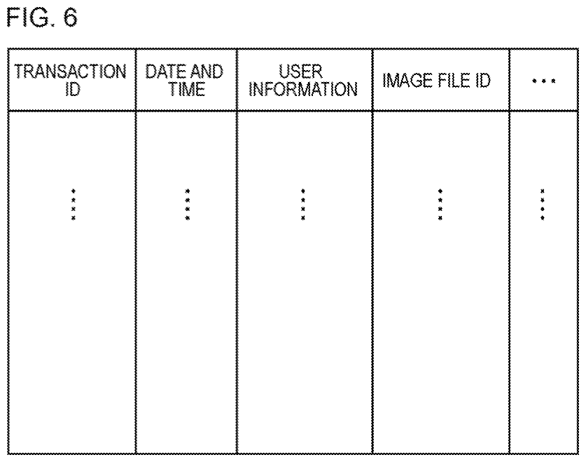

Consequently, information illustrated in FIG. 6 is accumulated in the accumulation apparatus 30. The information illustrated in FIG. 6 associates a transaction identifier (ID) with a date and time, user information, an image file ID, and the like. The date and time is the date and time of the transaction. The user information is information obtained from the information input through the transaction terminal 20 and is information indicating a user performing the transaction. The image file ID is the ID of the image file generated during each transaction. It should be noted that other information may be accumulated in the accumulation apparatus 30. For example, the information indicating the transaction content (example: transaction type or amount of money of the transaction) may be accumulated in association with the transaction ID.

Data (hereinafter, “processing object data”) of an image file group associated with the transaction date and time is generated on the basis of the information accumulated in the accumulation apparatus 30. The image file is an image file of a still picture or a motion picture obtained by capturing the person performing the transaction. The generation unit 11 generates the frequency data based on the processing object data. It should be noted that from the viewpoint of reducing abuse of private information, the transaction history including the user information, the transaction content, and the like may not be included in the processing object data.

Next, a process of generating the frequency data from the processing object data will be described. The process includes (1) a process of collectively grouping image files in which the same person is captured and (2) a process of generating the frequency data for each group. The generation unit 11 may execute those processes on the basis of the processing object data generated in correspondence with one transaction terminal 20. In this case, the frequency data indicating a temporal change in a transaction frequency in one transaction terminal 20 is generated. Besides, a plurality of pieces of processing object data generated in correspondence with the plurality of transaction terminals 20 may be collectively set as the processing object, and those processes may be executed. In this case, the frequency data indicating a temporal change in the transaction frequency in the plurality of transaction terminals 20 is generated.

First, (1) the process of collectively grouping the image files in which the same person is captured will be described. The process can be implemented by extracting a person from each of a plurality of image files, extracting a feature value of the appearance of the person extracted from each of the plurality of image files, and collecting the image files having similar feature values of appearance. While a specific algorithm is a design matter, using a technology below can implement efficient grouping.

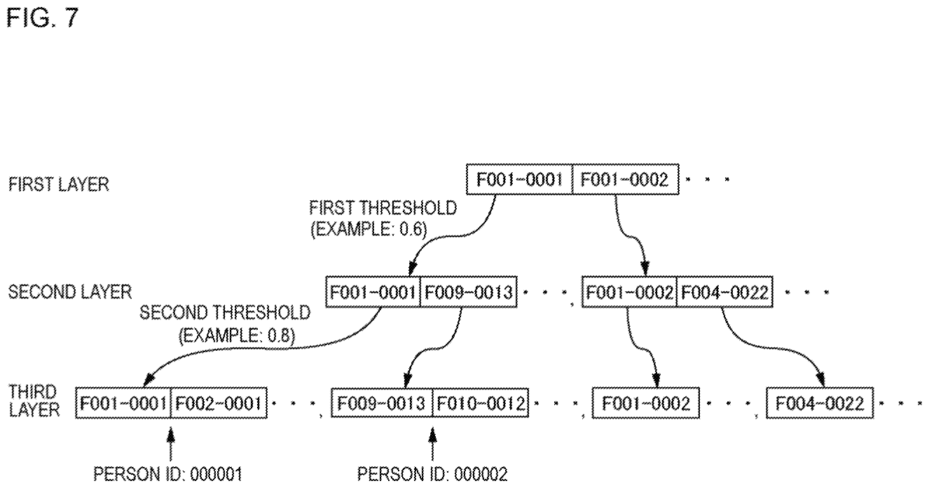

The technology is a technology for collectively grouping persons who are extracted from the plurality of image files (a plurality of still picture files, a plurality of frames of a motion picture, or the like) and who are the same person efficiently. Specifically, the grouping is performed using an index illustrated in FIG. 7. In the index, the person extracted from each of the plurality of image files is layered. The person detected from each image file is assigned a unique ID. This ID is called a detection ID. For example, F001-0001 indicates the detection ID illustrated in FIG. 7. F001 indicates the ID of the image file. The number of 4 digits after “-” is a number for identifying one or a plurality of persons extracted from each image file.

In the third layer, a node corresponding to each of all detection IDs obtained from all image files processed up to the present time is arranged. In a plurality of nodes arranged in the third layer, nodes having the similarity of the feature value greater than or equal to a predetermined value are collectively grouped. For example, one group in the third layer represents a group in which the detection IDs of persons estimated to be the same person are collected. Therefore, in FIG. 7, each group of the third layer is assigned a person ID that is a unique ID.

In the second layer, one node (representative node) selected from each of a plurality of groups of the third layer is arranged. The representative node is linked to the group of the third layer to which the representative node belongs. In a plurality of nodes arranged in the second layer, nodes having the similarity of the feature value greater than or equal to a predetermined value are collectively grouped. It should be noted that a reference (first threshold) of the similarity in the grouping in the second layer is lower than a reference (second threshold) of the similarity in the grouping in the third layer.

In the first layer, one node (representative node) selected from each of a plurality of groups of the second layer is arranged. The representative node is linked to the group of the second layer to which the representative node belongs.

Next, a flow of process of generating such an index will be briefly described. The generation unit 11 arranges a node corresponding to the initial detection ID in all layers and links the nodes to each other. The person ID is issued corresponding to the node of the third layer. Subsequent detection IDs are indexed as follows.

First, the generation unit 11 calculates the similarity between each node of the first layer and a detection ID to be indexed. The “similarity between each node and a detection ID to be indexed” is the similarity of appearance between a person determined by the detection ID corresponding to each node and a person determined by the detection ID to be indexed.

In a case where the similarity with respect to any node is less than the first threshold, the generation unit 11 arranges a node corresponding to the detection ID to be indexed in each layer and links the nodes to each other. It should be noted that in any of the second layer and the third layer, the new node is set to not belonging to any group but to belonging to a new group. A person ID is issued corresponding to the new node of the third layer.

On the other hand, in a case where the similarity with respect to any node of the first layer is greater than or equal to the first threshold, the generation unit 11 calculates the similarity between each node included in the group of the second layer (group to be processed in the second layer) linked to the node of the first layer having the similarity greater than or equal to the first threshold and the detection ID to be indexed.

In a case where the similarity with respect to any node is less than the second threshold, the generation unit 11 arranges a node corresponding to the detection ID to be indexed in the second layer and the third layer and links the nodes to each other. It should be noted that the new node arranged in the second layer belongs to the group to be processed in the second layer. The new node arranged in the third layer is set to not belonging to any group but to belonging to a new group. A person ID is issued corresponding to the new node of the third layer.

On the other hand, in a case where the similarity with respect to any node of the group to be processed in the second layer is greater than or equal to the second threshold, the generation unit 11 arranges a node corresponding to the detection ID to be indexed in the third layer and sets the node to belong to the same group as the node having the similarity greater than or equal to the second threshold.

Next, (2) the process of generating the frequency data for each group (for each person) will be described. The frequency data is data indicating a temporal change in the occurrence frequency of the transaction (predetermined event) for each person. In the present example embodiment, the frequency data is generated on the assumption that in a case where a person is captured in the image file (in a case where an image file in which a face is captured is generated), the person performs the transaction.

The frequency data may be data indicating the cumulative number of transactions per unit time. For example, the unit time is illustrated as 1 day. The unit time may also have other values such as 2 minutes, 10 minutes, 1 hour, 12 hours, 1 week, and 1 month.

Returning to FIG. 2 to FIG. 4, the extraction unit 12 extracts a person (processing object) having the first feature appearing in the frequency data as the possible abnormal object. The first feature is a feature appearing in the past frequency data obtained in the presence of abnormality (when the abnormal transaction is performed). The first feature is a feature that does not appear in the past frequency data obtained in the absence of abnormality.

The first feature is registered in advance in the extraction unit 12. The extraction unit 12 detects the frequency data in which the first feature appears.

For example, the first feature may be indicated by at least one of the occurrence frequency of the predetermined event in a predetermined period, a degree to which the occurrence of the predetermined event is concentrated in a partial period of the predetermined period, and the inclination of a broken line graph showing a temporal change in the occurrence frequency of the predetermined event with one axis denoting time and another axis denoting the occurrence frequency.

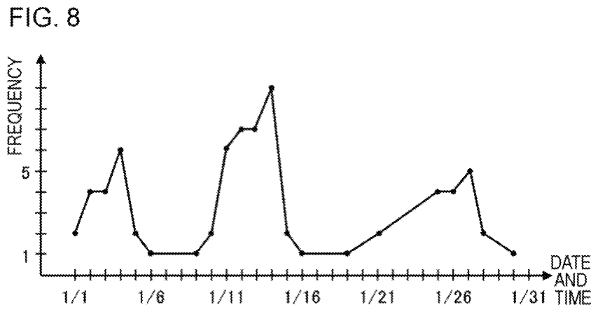

For example, the first feature may be such that the “number of occurrences of the transaction in the predetermined period is greater than or equal to a first reference value (design matter)”. One example of the frequency data in which the first feature appears is illustrated in FIG. 8. In the drawing, the horizontal axis denotes time, and the vertical axis denotes the occurrence frequency (number of times). A temporal change in the occurrence frequency of the predetermined event is illustrated by a broken line graph by plotting the occurrence frequency corresponding to the unit time at which the predetermined event occurs once or more and connecting the plots in time series. All broken line graphs described below are represented in the same manner.

By appropriately setting the first reference value, a person having an abnormally large number of occurrences of the transaction in the predetermined period (in the case of the example in FIG. 8, one month from January 1 until January 31) can be extracted as the possible abnormal object.

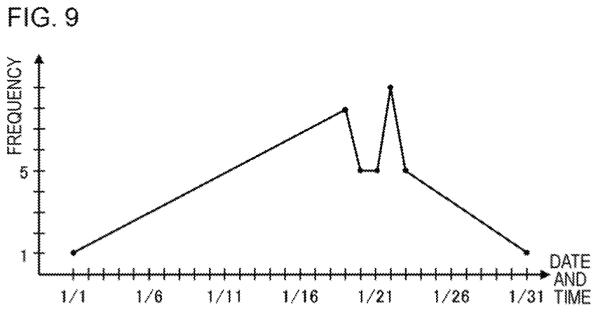

Besides, the first feature may be such that the “number of occurrences of the transaction in the predetermined period is greater than or equal to a second reference value (design matter), and the occurrence of the transaction is concentrated in the partial period of the predetermined period”. The “second reference value” is less than the first reference value. For example, the “partial period” may be less than or equal to ⅔ or less than or equal to half of the predetermined period. The “state of concentration in the partial period” is a state where a predetermined number (example: half) or more of transactions occurring in the predetermined period occurs in the partial period. One example of the frequency data in which the first feature appears is illustrated in FIG. 9.

By detecting the first feature, a person who has a certainly large number of occurrences of the transaction in the predetermined period (in the case of the example in FIG. 8, one month from January 1 until January 31) and of whom the transaction occurrences are concentrated in the partial period, can be extracted as the possible abnormal object.

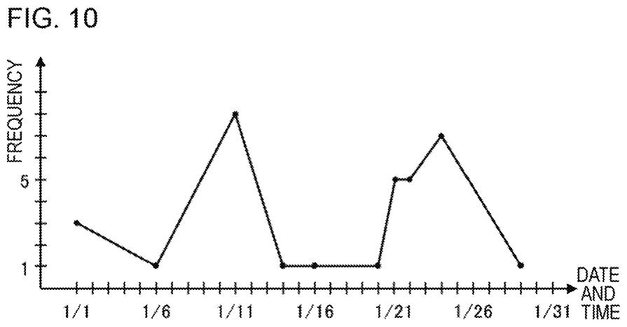

Besides, the first feature may be such that the “number of occurrences of the transaction in the predetermined period is greater than or equal to a third reference value (design matter), and in a broken line graph showing a temporal change in the occurrence frequency of the predetermined event with the horizontal axis denoting time and the vertical axis denoting the occurrence frequency, there is a part in which the absolute value of inclination (hereinafter, the “inclination of the graph”) is greater than or equal to a fourth reference value (design matter)”. The “third reference value” is less than the first reference value. One example of the frequency data in which the first feature appears is illustrated in FIG. 8 to FIG. 10.

By detecting the first feature, a person having a certainly large number of occurrences of the transaction in the predetermined period (in the case of the example in FIG. 8, one month from January 1 until January 31) and having a significant change in cumulative number of transactions per unit time with respect to elapsed time can be extracted as the possible abnormal object.

Besides, the first feature may be such that the “number of occurrences of the transaction in the predetermined period is greater than or equal to a fifth reference value (design matter), and the range (difference between the maximum value and the minimum value) of the cumulative number of transactions per unit time in the predetermined period is greater than or equal to a sixth reference value (design matter)”. The “fifth reference value” is less than the first reference value. One example of the frequency data in which the first feature appears is illustrated in FIG. 8 to FIG. 10.

By detecting the first feature, a person having a certainly large number of occurrences of the transaction in the predetermined period (in the case of the example in FIG. 8, 1 month from January 1 until January 31) and having a significant change in cumulative number of transactions per unit time (in the case of the example in FIG. 8, 1 day) can be extracted as the possible abnormal object.

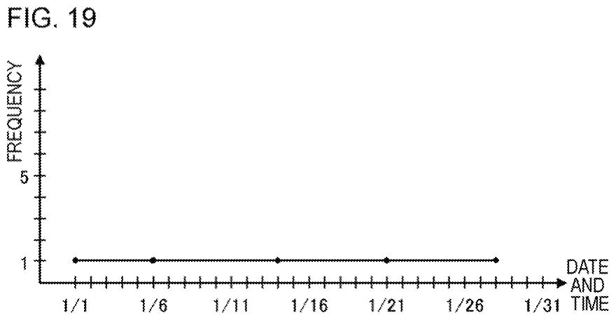

One example of the frequency data obtained in the absence of abnormality is illustrated in FIG. 19. As illustrated, the number of occurrences of the transaction in the predetermined period is typically less than or equal to a certain level. In addition, the occurrence of the transaction is distributed and is not concentrated in a partial period. In addition, the cumulative number of transactions per unit time is stable at small values and has a narrow range. In addition, since the cumulative number of transactions per unit time does not significantly change in a short period, the absolute value of the inclination of the graph is less than or equal to a certain level.

It should be noted that the extraction unit 12 may exclude the possible abnormal object having the second feature appearing in the frequency data from the extracted possible abnormal objects. The second feature is a feature appearing in the past frequency data obtained in the absence of abnormality. The second feature is a feature that does not appear in the past frequency data obtained in the presence of abnormality.

The second feature can include at least one of a feature commonly applied to all persons and a feature set for each person.

The second feature commonly applied to all persons is a feature appearing in the “past frequency data obtained in the absence of abnormality” of a plurality of persons. For example, the second feature may be a feature appearing in the “past frequency data obtained in the absence of abnormality” of a predetermined percentage of persons or more. By analyzing a plurality of pieces of the “past frequency data obtained in the absence of abnormality”, the second feature can be extracted.

The second feature set for each person is a feature appearing in the “past frequency data obtained in the absence of abnormality” of each person. For example, the tendency of temporal change in the occurrence frequency of the transaction may be computed by analyzing the “past frequency data obtained in the absence of abnormality” of each person. The tendency may be set as the second feature of each person.

Returning to FIG. 3 and FIG. 4, the determination unit 13 determines whether or not the person who is the possible abnormal object is the abnormal transactor on the basis of the transaction history of the transaction terminal 20. The determination unit 13 obtains the transaction history associated with the image file of the person who is the possible abnormal object from the transaction history accumulated (refer to FIG. 6) in the accumulation apparatus 30 and performs the determination based on the transaction history. The transaction history associated with the image file of the person who is not the possible abnormal object may not be obtained. Hereinafter, one example of the determination process of the determination unit 13 will be described.

“Determination Process 1”

The determination unit 13 can determine whether or not the person who is the possible abnormal object is the abnormal transactor on the basis of input information that is input into the transaction terminal 20 in the transaction by the person who is the possible abnormal object. The input information used for determination includes an account number and/or an account holder (user ID).

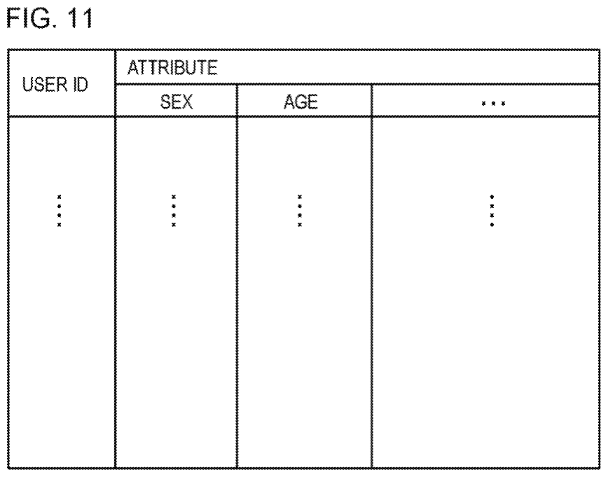

As illustrated in FIG. 11, a user attribute is registered in advance in association with each user ID (or account number). The user attribute includes sex, age, an address, and the like. The determination unit 13 determines the user attribute registered in association with the user ID or the account number included in the input information on the basis of the input information and registration information illustrated in FIG. 8.

In addition, by performing image analysis based on the image file of the person who is the possible abnormal object, the determination unit 13 estimates the user attribute of the person.

The determination unit 13 determines whether or not the user attribute (example: sex and age) registered in association with the user ID or the account number included in the input information matches the user attribute (example: sex and age) estimated by image analysis based on the image file and related to the person who is the possible abnormal object. In a case where the user attributes do not match, the determination unit 13 determines that the person who is the possible abnormal object is the abnormal transactor.

In addition, the determination unit 13 can determine whether or not the person who is the possible abnormal object is the abnormal transactor on the basis of the user attribute (example: an address) registered in association with the user ID or the account number included in the input information and the installation position of the transaction terminal 20. For example, in a case where the distance between the registered address and the installation position of the transaction terminal 20 is greater than or equal to a predetermined threshold, the determination unit 13 may determine that the person who is the possible abnormal object is the abnormal transactor.

In addition, in a case where the same person inputs a plurality of different account holders and performs the transaction, that is, in a case where the transactions are performed using a plurality of accounts having different account holders, the determination unit 13 may determine that the person who is the possible abnormal object is the abnormal transactor.

“Determination Process 2”

The determination unit 13 can determine whether or not the person who is the possible abnormal object is the abnormal transactor on the basis of input information that is input into the transaction terminal 20 in the transaction by the person who is the possible abnormal object. The input information used for determination includes the transaction content.

For example, in a case where the total value of the amounts of money of transfer transactions performed in a predetermined period by the person who is the possible abnormal object is above a threshold, it may be determined that the person who is the possible abnormal object is the abnormal transactor. Besides, in a case where the person who is the possible abnormal object withdraws the withdrawal limit amount of money a predetermined number of times or more in a predetermined period, it may be determined that the person who is the possible abnormal object is the abnormal transactor.

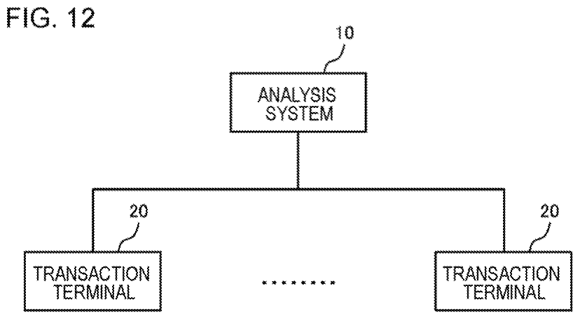

Returning to FIG. 4, the transmission unit 14 transmits information indicating the person determined as the abnormal transactor to the transaction terminal 20. As illustrated in FIG. 12, the analysis system 10 can communicate with each of the plurality of transaction terminals 20.

The transaction terminal 20 stores a list of persons determined as the abnormal transactor. When the image file obtained by capturing the person performing the transaction is generated, a determination as to whether or not the person performing the transaction is the abnormal transactor is performed by comparing the person with the list. In a case where a person on the list is detected, the transaction is stopped, or a predetermined user is notified.

It should be noted that the analysis system 10 may output the broken line graph illustrated in FIG. 8 to FIG. 10 and FIG. 19 to the user. The output is performed through a so-called output apparatus such as a display, a printer, an emailer, or a projector.

For example, the analysis system 10 may collectively display the broken line graph based on the frequency data of the person determined as the abnormal transactor. Besides, the analysis system 10 may collectively display the broken line graph based on the frequency data of the person who is the possible abnormal object. By doing so, data necessary for analysis can be narrowed down and output.

It should be noted that while illustration is not provided, the analysis system 10 may also show the content of the detected first feature when outputting the broken line graph illustrated in FIG. 8 to FIG. 10 and FIG. 19. For example, a message “since the number of occurrences of the transaction in one month is greater than or equal to the first reference value, you are extracted as the possible abnormal object” may be displayed in association with the broken line graph illustrated in FIG. 8.

In addition, in the broken line graph illustrated in FIG. 8 to FIG. 10 and FIG. 19, in a case where an input specifying any day on which the transaction occurs is received, the analysis system 10 may display an image captured in the transaction performed on the specified day on a screen.

By performing such output, the user can efficiently verify the analysis result of the analysis system 10.

Next, one example of a flow of process of the analysis system 10 of the present example embodiment will be described.

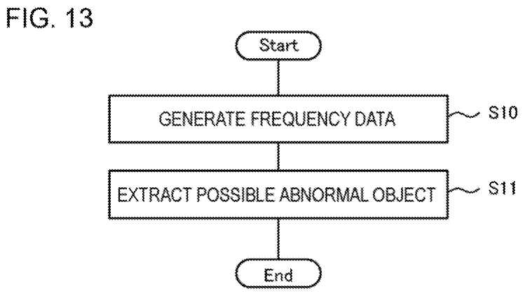

As illustrated in the flowchart in FIG. 13, when the generation unit 11 generates the frequency data indicating a temporal change in the occurrence frequency of the transaction for each person on the basis of the image data obtained by capturing the site of the transaction (S10), the extraction unit 12 extracts the person having the first feature appearing in the frequency data as the possible abnormal object (S11).

According to the process, the person having the possibility of performing the abnormal transaction can be extracted from among a plurality of persons captured in the image on the basis of the tendency of temporal change in the occurrence frequency of the transaction without using the information indicating the transaction content.

By narrowing down the persons to the extracted possible abnormal object and performing the subsequent examination, analysis, investigation, and the like, the efficiency of these works is improved.

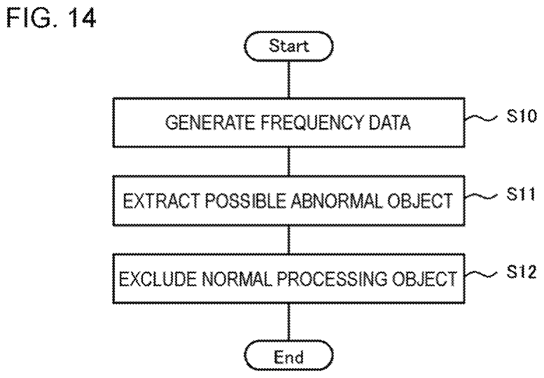

It should be noted that as illustrated in the flowchart in FIG. 14, after S11, the extraction unit 12 may exclude the person having the second feature appearing in the frequency data from the possible abnormal objects extracted in S11 (S12).

According to the process, the person having the possibility of performing the abnormal transaction can be more accurately narrowed down. Consequently, the efficiency of work of the subsequent examination, analysis, investigation, and the like is improved.

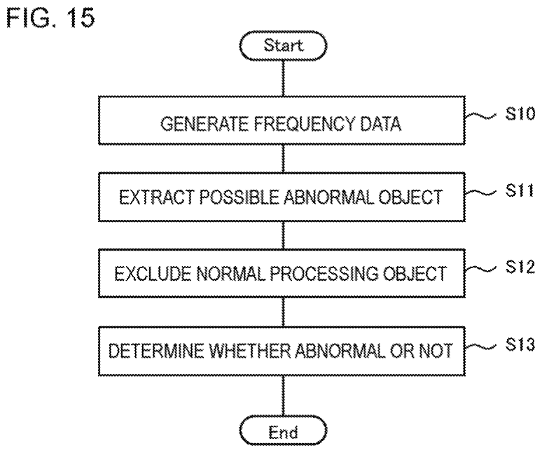

In addition, as illustrated in a flowchart in FIG. 15, after S12, the determination unit 13 may determine whether or not the person who is the possible abnormal object is the abnormal transactor on the basis of the transaction history of the transaction terminal 20 (S13).

According to the process, by narrowing down the possible abnormal objects using the frequency data and the transaction history, the abnormal transactor having a high possibility of actually performing the abnormal transaction can be accurately extracted.

In addition, according to the process of extracting the possible abnormal object on the basis of the tendency of temporal change in the occurrence frequency of the transaction and then, applying the determination using the transaction history to the extracted possible abnormal object, it is not necessary to use the transaction histories of all persons, and only the transaction histories of some persons especially determined as the possible abnormal object may be used. Thus, abuse of private information can be reduced.

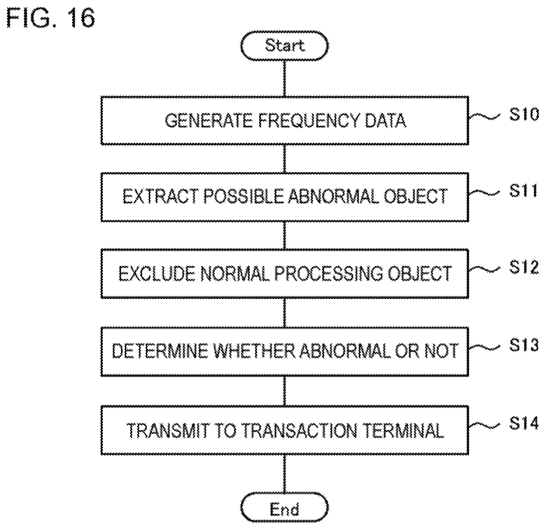

In addition, as illustrated in a flowchart in FIG. 16, after S13, the transmission unit 14 may transmit information indicating the person determined as the abnormal transactor to the transaction terminal 20. As described above, the transaction terminal 20 determines whether or not the person performing the transaction is the abnormal transactor using the list of persons determined as the abnormal transactor, and stops the transaction or notifies the predetermined user depending on the result of the determination.

According to the process, prevention of the abnormal transaction performed by the abnormal transactor, aid in arresting the person, and the like are achieved.

Next, an advantageous effect of the present example embodiment will be described.

According to the analysis system 10 of the present example embodiment, a new technology for detecting the abnormal transaction is achieved.

In addition, according to the analysis system 10 of the present example embodiment, an object (possible abnormal object) having the possibility of performing the abnormal transaction can be extracted without using private information indicating the transaction content such as the amount of money of the transaction. Since it is not necessary to use private information, versatility is increased.

In addition, according to the analysis system 10 of the present example embodiment, the possible abnormal object can be extracted or excluded on the basis of the feature appearing in the past frequency data obtained in the presence of abnormality, the feature appearing in the past frequency data obtained in the absence of abnormality, and the like. Consequently, the possible abnormal object can be accurately extracted.

In addition, according to the analysis system 10 of the present example embodiment, a determination as to whether or not the possible abnormal object is the abnormal transactor can be performed on the basis of the transaction history. By extracting the abnormal transactor using a combination of the frequency data and the transaction history, the abnormal transactor having a high possibility of actually performing the abnormal transaction can be accurately extracted.

It should be noted that since the determination using the transaction history may be applied to only the possible abnormal object, it is not necessary to use the transaction histories of all persons. Thus, abuse of private information can be reduced.

In addition, according to the analysis system 10 of the present example embodiment, the transaction terminal 20 can be notified of the person determined as the abnormal transactor. The transaction terminal 20 determines whether or not the person performing the transaction is the abnormal transactor using the list of persons determined as the abnormal transactor, and stops the transaction or notifies the predetermined user depending on the result of the determination. Thus, prevention of the abnormal transaction performed by the abnormal transactor, aid in arresting the person, and the like are achieved.

In a case where transactions performed by the same person across the plurality of transaction terminals 20 cannot be collected, the accuracy of extracting the abnormal transaction is decreased. For example, in the invention of Patent Document 1 in which transactions performed by the same person across a plurality of transaction terminals are not collected, in a case where transactions are performed across the plurality of transaction terminals, even in a case where the total value of the amounts of money of transfer transaction performed by the same person is actually above the threshold, the object cannot be extracted. According to the analysis system 10 of the present example embodiment, the abnormal transactor can be extracted by computing a temporal change in the transaction frequency by collecting transactions performed by the same person across the plurality of transaction terminals 20. Thus, the accuracy of extracting the abnormal transactor is favorable.

A modification example will be described. The modification example can be applied to all example embodiments below. The modification example can achieve the same advantageous effect as each example embodiment.

While the frequency data is generated on the basis of the image data of the still image obtained by capturing the site of the transaction in the above description, the frequency data may be generated on the basis of the image data of a motion image obtained by capturing the site of the transaction. In this case, the same advantageous effect can be achieved by the same process using data of each frame as the image data of the still image.

In this case, the frequency data may be data indicating the cumulative amount of time of the transaction per unit time instead of the data indicating the cumulative number of transactions per unit time. The cumulative amount of time of the transaction is the cumulative amount of time in which each person is captured in the motion mage within the unit time.

In addition, while the predetermined event is the transaction (example: deposit, withdrawal, transfer, or bank-book updating) using the ATM in the above description, the predetermined event may be other events. For example, the predetermined event may be a transaction (payment) using a credit card or a membership card. In this case, the camera included in the transaction terminal 20 obtaining information from the card or a camera installed near the transaction terminal 20 captures (as a motion image or a still image) a card user. The analysis system 10 extracts a person at a predetermined position at any timing from the image data and recognizes the person as a transactor. For example, in a case where information is obtained from the card, a person in front of an accounting apparatus may be recognized as the transactor. Then, in the same manner as described above, the analysis system 10, for example, extracts the possible abnormal object by analyzing the image data, extracts the abnormal transactor using the transaction history, and notifies the transaction terminal 20 of the abnormal transactor.

### Second Example Embodiment

For example, the analysis system 10 of the present example embodiment is different from the analysis system 10 of the first example embodiment in the following points. The analysis system 10 of the present example embodiment generates the frequency data indicating a temporal change in the occurrence frequency of the transaction for each user ID (example: account holder) or for each account number on the basis of the transaction history of the transaction terminal 20. The analysis system 10 extracts the user ID or the account number having the first feature appearing in the frequency data as the possible abnormal object. The analysis system 10 determines whether or not the user ID or the account number which is the possible abnormal object is the object of the abnormal transaction on the basis of the image data obtained by capturing the site of the transaction.

Next, a configuration of the analysis system 10 will be described in detail. One example of a hardware configuration of the analysis system 10 of the present example embodiment is the same as that of the first example embodiment.

One example of a function block diagram of the analysis system 10 of the present example embodiment is illustrated in FIG. 2 to FIG. 4 in the same manner as the first example embodiment.

The generation unit 11 generates the frequency data indicating a temporal change in the occurrence frequency of the predetermined event for each processing object. The predetermined event is a transaction (example: deposit, withdrawal, transfer, or bank-book updating) using an ATM. The processing object is the user ID (example: account holder) or the account number.

The frequency data may be data indicating the cumulative number of transactions per unit time. For example, the unit time is illustrated as 1 day. The unit time may also have other values such as 2 minutes, 10 minutes, 1 hour, 12 hours, 1 week, and 1 month.

The extraction unit 12 extracts the user ID or the account number having the first feature appearing in the frequency data as the possible abnormal object. The first feature is a feature appearing in the past frequency data obtained in the presence of abnormality (when the abnormal transaction is performed). The first feature is a feature that does not appear in the past frequency data obtained in the absence of abnormality. Details of the first feature and details of the process of extracting the processing object having the first feature appearing in the frequency data as the possible abnormal object are the same as those of the first example embodiment. The processing object may be changed from the “person” to the “user ID or the account number”.

In addition, the extraction unit 12 may exclude the possible abnormal object having the second feature appearing in the frequency data from the extracted possible abnormal objects. The second feature is a feature appearing in the past frequency data obtained in the absence of abnormality. The second feature is a feature that does not appear in the past frequency data obtained in the presence of abnormality. Details of the second feature and details of the process of excluding the processing object having the second feature appearing in the frequency data from the possible abnormal objects are the same as those of the first example embodiment. The processing object may be changed from the “person” to the “user ID or the account number”.

The determination unit 13 determines whether or not the user ID or the account number which is the possible abnormal object is the object of the abnormal transaction on the basis of the image data obtained by capturing the site of the transaction. The determination unit 13 obtains the image file (refer to FIG. 6) associated with the user ID or the account number which is the possible abnormal object from among the image files accumulated in the accumulation apparatus 30 and performs the determination on the basis of the image file. The image file associated with the user ID or the account number that is not the possible abnormal object may not be obtained. By doing so, a communication load and a process load can be reduced.

The process of the determination unit 13 is the same as that of the first example embodiment. That is, the determination unit 13 can determine whether or not the user ID or the account number which is the possible abnormal object is the object of the abnormal transaction on the basis of the user attribute registered in association with the user ID or the account number which is the possible abnormal object and the user attribute estimated from the image data and related to the person who uses the user ID or the account number which is the possible abnormal object in the transaction.

For example, in a case where the user attribute (example: sex and age) registered in association with the user ID or the account number which is the possible abnormal object does not match the user attribute (example: sex and age) estimated from the image data and related to the person who uses the user ID or the account number which is the possible abnormal object in the transaction, the determination unit 13 can determine that the user ID or the account number of the possible abnormal object is the object of the abnormal transaction.

Besides, in a case where one user ID or account number which is the possible abnormal object is used by a plurality of persons (the number of persons is a design matter), that is, in a case where one account which is the possible abnormal object is used by a plurality of persons, the determination unit 13 can determine that the user ID or the account number which is the possible abnormal object is the object of the abnormal transaction.

Besides, the determination unit 13 can determine whether or not the user ID or the account number which is the possible abnormal object is the object of the abnormal transaction on the basis of the user attribute (example: address) registered in association with the user ID or the account number which is the possible abnormal object and the installation position of the transaction terminal 20. For example, in a case where the distance between the registered address and the installation position of the transaction terminal 20 is greater than or equal to the predetermined threshold, the determination unit 13 may determine that the user ID or the account number which is the possible abnormal object is the object of the abnormal transaction.

The transmission unit 14 transmits the user ID or the account number determined as the object of the abnormal transaction to the transaction terminal 20. As illustrated in FIG. 12, the analysis system 10 can communicate with each of the plurality of transaction terminals 20.

The transaction terminal 20 stores a list of user IDs or account numbers determined as the object of the abnormal transaction. In a case where a transaction using the user ID or the account number determined as the object of the abnormal transaction is performed, the transaction can be detected using the list. The transaction is stopped, or the predetermined user is notified.

It should be noted that the analysis system 10 may output the broken line graph illustrated in FIG. 8 to FIG. 10 and FIG. 19 to the user in the same manner as the first example embodiment. Details are the same as those of the first example embodiment.

Next, one example of a flow of process of the analysis system 10 of the present example embodiment will be described.

As illustrated in the flowchart in FIG. 13, in a case where the generation unit 11 generates the frequency data indicating a temporal change in the occurrence frequency of the transaction for each user ID or account number on the basis of the transaction history of the transaction terminal 20 (S10), the extraction unit 12 extracts the user ID or the account number having the first feature appearing in the frequency data as the possible abnormal object (S11).

According to the process, the user ID or the account number having the possibility that the abnormal transaction is performed therewith can be extracted on the basis of the tendency of temporal change in the occurrence frequency of the transaction without using the information indicating the transaction content.

By narrowing down objects to the extracted possible abnormal object and performing the subsequent examination, analysis, investigation, and the like, the efficiency of these works is improved.

It should be noted that as illustrated in the flowchart in FIG. 14, after S11, the extraction unit 12 may exclude the user ID or the account number having the second feature appearing in the frequency data from the possible abnormal objects extracted in S11 (S12).

According to the process, the user ID or the account number having the possibility of the abnormal transaction can be more accurately narrowed down. Consequently, the efficiency of work of the subsequent examination, analysis, investigation, and the like is improved.

In addition, as illustrated in the flowchart in FIG. 15, after S12, the determination unit 13 may determine whether or not the user ID or the account number which is the possible abnormal object is the object of the abnormal transaction on the basis of the image data obtained by capturing the site of the transaction (S13).

According to the process, a determination as to whether or not the possible abnormal object extracted on the basis of the tendency of temporal change in the occurrence frequency of the transaction is the object of the abnormal transaction can be performed on the basis of the image data obtained by capturing the site of the transaction. By performing the determination using the transaction history and other data (example: image data), the user ID or the account number having a high possibility that the abnormal transaction is performed therewith can be accurately extracted.

In addition, as illustrated in the flowchart in FIG. 16, after S13, the transmission unit 14 may transmit information indicating the user ID or the account number determined as the object of the abnormal transaction to the transaction terminal 20. As described above, by using the list of user IDs or account numbers determined as the object of the abnormal transaction, the transaction terminal 20 detects the transaction using the user ID or the account number and stops the transaction or notifies the predetermined user.

According to the process, prevention of the abnormal transaction, aid in arresting the person performing the abnormal transaction, and the like are achieved.

Next, the analysis system 10 of the present example embodiment can achieve the same advantageous effect as the analysis system 10 of the first example embodiment.

### Third Example Embodiment

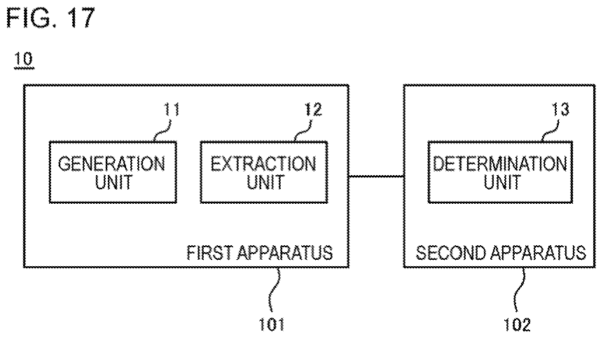

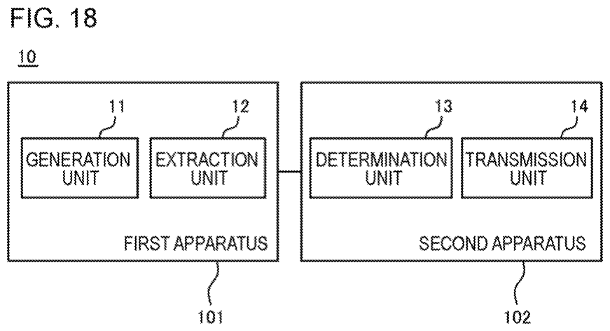

FIG. 17 and FIG. 18 illustrate one example of a function block diagram of the analysis system 10 of the present example embodiment. As illustrated, the analysis system 10 includes a first apparatus 101 and a second apparatus 102. The first apparatus 101 and the second apparatus 102 are configured to be physically and/or logically separated from each other. The first apparatus 101 and the second apparatus 102 can communicate with each other by any unit.

The first apparatus 101 includes the generation unit 11 and the extraction unit 12. The second apparatus 102 includes the determination unit 13 (FIG. 17 and FIG. 18). As illustrated in FIG. 18, the second apparatus 102 may include the transmission unit 14. The configurations of the generation unit 11, the extraction unit 12, the determination unit 13, and the transmission unit 14 are the same as those of the first and second example embodiments.

While the determination unit 13 of the first example embodiment performs its process using the transaction history, the determination unit 13 can be configured to be separated from other functional units. In such a case, the transaction history can be stored in the second apparatus 102 and does not need to be input into the first apparatus 101.

For example, by disposing the second apparatus 102 under management of an entity managing the transaction history and disposing the first apparatus 101 under management of another entity, the object of the abnormal transaction and the abnormal transactor can be determined without outputting the transaction history to the outside of the entity that manages the transaction history.

Reference examples are appended below.

What is claimed is:

1. An analysis system comprising:
at least one memory configured to store one or more instructions; and
at least one processor configured to execute the one or more instructions to:
generate frequency data indicating a temporal change in an occurrence frequency of a predetermined event for each processing object; and
extract the processing object having a first feature appearing in the frequency data as a possible abnormal object.

2. The analysis system according to claim 1,
wherein the first feature is a feature appearing in the past frequency data obtained in a presence of abnormality.

3. The analysis system according to claim 2,
wherein the first feature is indicated by at least one of the occurrence frequency of the predetermined event in a predetermined period, a degree to which occurrence of the predetermined event is concentrated in a partial period of the predetermined period, and an inclination of a broken line graph showing the temporal change in the occurrence frequency of the predetermined event with one axis denoting time and another axis denoting the occurrence frequency.

4. The analysis system according to claim 1,
wherein the processor is further configured to execute the one or more instructions to exclude the possible abnormal object having a second feature appearing in the frequency data from the possible abnormal objects.

5. The analysis system according to claim 4,
wherein the second feature is a feature appearing in the past frequency data obtained in an absence of abnormality.

6. The analysis system according to claim 5,
wherein the second feature includes at least one of a feature commonly applied to all processing objects and a feature set for each processing object.

The analysis system according to claim 6,
wherein the second feature commonly applied to all processing objects is a feature appearing in the frequency data of a plurality of the processing objects.

8. The analysis system according to claim 6,
wherein the second feature set for each processing object is a feature appearing in the frequency data of each processing object.

9. The analysis system according to claim 1,
wherein the processing object is a person,
wherein the predetermined event is a transaction, and
wherein the processor is further configured to execute the one or more instructions to generate the frequency data indicating the temporal change in the occurrence frequency of the transaction for each person on the basis of image data obtained by capturing a site of the transaction.

10. The analysis system according to claim 9,
wherein the processor is further configured to execute the one or more instructions to determine whether or not a person who is the possible abnormal object is an abnormal transactor on the basis of a transaction history of a transaction terminal.

11. The analysis system according to claim 10,
wherein the processor is further configured to execute the one or more instructions to determine whether or not the person who is the possible abnormal object is the abnormal transactor on the basis of input information that is input into the transaction terminal in the transaction by the person who is the possible abnormal object.

12. The analysis system according to claim 11,
wherein the input information includes a user identifier (ID) and/or an account number used in the transaction.

13. The analysis system according to claim 12,
wherein the processor is further configured to execute the one or more instructions to determine whether or not the person who is the possible abnormal object is the abnormal transactor on the basis of a user attribute registered in association with the user ID or the account number included in the input information and a user attribute estimated from the image data and related to the person who is the possible abnormal object.

14. The analysis system according to claim 10
wherein the processor is further configured to execute the one or more instructions to transmit information indicating the person determined as the abnormal transactor to the transaction terminal.

15. The analysis system according to claim 1,
wherein the processing object is a user ID or an account number,
wherein the predetermined event is a transaction, and
wherein the processor is further configured to execute the one or more instructions to generate the frequency data indicating the temporal change in the occurrence frequency of the transaction for each user ID or for each account number on the basis of a transaction history of a transaction terminal.

16. The analysis system according to claim 15,
wherein the processor is further configured to execute the one or more instructions to determine whether or not the user ID or the account number which is the possible abnormal object is an object of an abnormal transaction on the basis of image data obtained by capturing a site of the transaction.

17. The analysis system according to claim 16,
wherein the processor is further configured to execute the one or more instructions to determine whether or not the user ID or the account number which is the possible abnormal object is the object of the abnormal transaction on the basis of a person who uses the user ID or the account number which is the possible abnormal object in the transaction.

18. The analysis system according to claim 16,
wherein the processor is further configured to execute the one or more instructions to determine whether or not the user ID or the account number which is the possible abnormal object is the object of the abnormal transaction on the basis of a user attribute registered in association with the user ID or the account number which is the possible abnormal object and a user attribute estimated from the image data and related to a person who uses the user ID or the account number which is the possible abnormal object in the transaction.

19. The analysis system according to claim 16,
wherein the processor is further configured to execute the one or more instructions to transmit the user ID or the account number determined as the object of the abnormal transaction to the transaction terminal.

20. The analysis system according to claim 10, comprising:
a first apparatus that generates frequency data indicating a temporal change in an occurrence frequency of a predetermined event for each processing object; and
a second apparatus that determines whether or not a person who is the possible abnormal object is an abnormal transactor on the basis of a transaction history of a transaction terminal,
wherein the first apparatus and the second apparatus are configured to be physically separated and communicable with each other.

21. (canceled)

22. (canceled)
